(19) United States
(12) Patent Application Publication
(10) Pub. No.: US 2006/0185399 A1
(43) Pub. Date: Aug. 24, 2006

(54) Apparatus for fabricating optical fiber preform through external vapor deposition process

(75) Inventors: Myung-Hwan Pyo, Gumi-si (KR); Jin-Seong Yang, Gumi-si (KR); Mun-Hyun Do, Gyeongsangbuk-do (KR)

Correspondence Address: CHA & REITER, LLC, 210 ROUTE 4 EAST STE 103, PARAMUS, NJ, 07652, US

(73) Assignee: Samsung Electronics Co., LTD

(21) Appl. No.: 11/243,703

(22) Filed: Oct. 5, 2005

(30) Foreign Application Priority Data
Feb. 23, 2005 (KR) 2005-15163
Apr. 26, 2005 (KR) 2005-34481

(51) Int. Cl. C03B 37/018

(52) U.S. Cl. 65/531

(57) ABSTRACT

Disclosed is an apparatus for fabricating an optical fiber preform through an external vapor deposition process. The apparatus includes a lathe on which a primary preform is rotatably mounted by chucks, a burner assembly including a burner installation block having an inclined surface and a plurality of burners installed on the inclined surface of the burner installation block in such a manner that the burners spray flames and source gas towards the primary preform with mutually different spraying angles, and a carrier unit for moving the burner assembly lengthwise along the primary preform.

### CLAIM OF PRIORITY

This application claims the benefit under 35 U.S.C. 119(a) of an application entitled “Apparatus For Fabricating Optical Preform Using Outside Vapor Deposition,” filed with the Korean Intellectual Property Office on Feb. 23, 2005 and assigned Serial No. 2005-15163 and an application entitled “Optical Vapor Deposition Apparatus For Optical Preform” filed with the Korean Intellectual Property Office on Apr. 26, 2005 and assigned Serial No. 2005-34481, the entire contents of which are incorporated herein by reference.

### BACKGROUND OF THE INVENTION

1. Field of the Invention

The present invention relates to an apparatus for fabricating an optical fiber preform. More particularly, the present invention relates to an apparatus for fabricating an optical fiber preform through an external vapor deposition process.

2. Description of the Related Art

An optical fiber preform undergoes a drawing process for fabrication of an optical fiber which serves as a transmission line for optical communication.

The optical fiber preform can be fabricated by over-cladding a primary preform having a rod shape obtained through an internal vapor deposition process onto a large-sized natural or synthetic quartz tube. More specifically, the optical fiber preform can be fabricated through an external vapor deposition process, in which soot is formed by oxidizing source gas under high temperature conditions and is then deposited around a primary preform.

The vapor deposition process is classified into an internal vapor deposition process in which a high-temperature area is formed in a quartz tube and soot generated by oxidizing source gas is deposited in the high-temperature area, and an external vapor deposition process in which a primary preform having a rod shape is heated and oxidized soot is deposited around the primary preform.

According to the internal vapor deposition process, the high-temperature area is formed in the quartz tube so that source gas introduced into the quartz tube is oxidized into the soot, and the soot is deposited on an inner wall of the quartz tube due to the thermophoresis effect.

According to the external vapor deposition process, the source gas and flame are sprayed onto the primary preform in such a manner that the soot can be deposited around the primary preform while flowing along a plasma jet. The external vapor deposition process is disclosed in detail in U.S. Pat. No. 4,486,212, which is entitled “Devitrification resistant flame hydrolysis process and issued to George. et. al. According to the George' process, the soot is deposited on an outer peripheral portion of a primary preform by means of a single burner. The primary preform and the secondary preform are called a “soot preform”. However, the single burner only generates a limited amount of soot and the soot cannot be evenly deposited lengthwise along the soot preform. In order to solve the above problem, an external vapor deposition process using a plurality of burners has been suggested.

An external vapor deposition apparatus using a plurality of burners raises equipment cost and makes it difficult to manage and repair the external vapor deposition apparatus. In particular, interference may occur between flames generated from the burners, thereby degrading characteristics of the optical fiber preform, such as a deposition rate, density, and an external appearance of the optical fiber preform.

### SUMMARY OF THE INVENTION

Accordingly, the present invention has been made to solve the above-mentioned problems occurring in the prior art and provides additional advantages, by providing an apparatus and a method for fabricating an optical fiber preform having superior characteristics by preventing interference between flames generated from a plurality of burners.

In one embodiment, there is provided an apparatus for fabricating an optical fiber preform through an external vapor deposition process which includes: a lathe on which a primary preform is rotatably mounted by means of chucks; a burner assembly including a burner installation block having an inclined surface and a plurality of burners installed on the inclined surface of the burner installation block in such a manner that the burners spray flames and source gas towards the primary preform with mutually different spraying angles; and a carrier unit for moving the burner assembly lengthwise along the primary preform.

### BRIEF DESCRIPTION OF THE DRAWINGS

The above features and advantages of the present invention will be more apparent from the following detailed description taken in conjunction with the accompanying drawings, in which:

FIG. 1 is a view illustrating an apparatus for fabricating an optical fiber preform through an external vapor deposition process according to an embodiment of the present invention;

FIG. 2 is a schematic view illustrating a structure of a burner assembly shown in FIG. 1;

FIG. 3 is a schematic view illustrating a structure of a burner assembly having four burners according to another embodiment of the present invention; and

FIG. 4 is a schematic view illustrating a structure of a burner assembly having three burners according to still another embodiment of the present invention.

### DETAILED DESCRIPTION

Hereinafter, embodiments of the present invention will be described with reference to the accompanying drawings. For the purposes of clarity and simplicity, a detailed description of known functions and configurations incorporated herein will be omitted as it may make the subject matter of the present invention unclear.

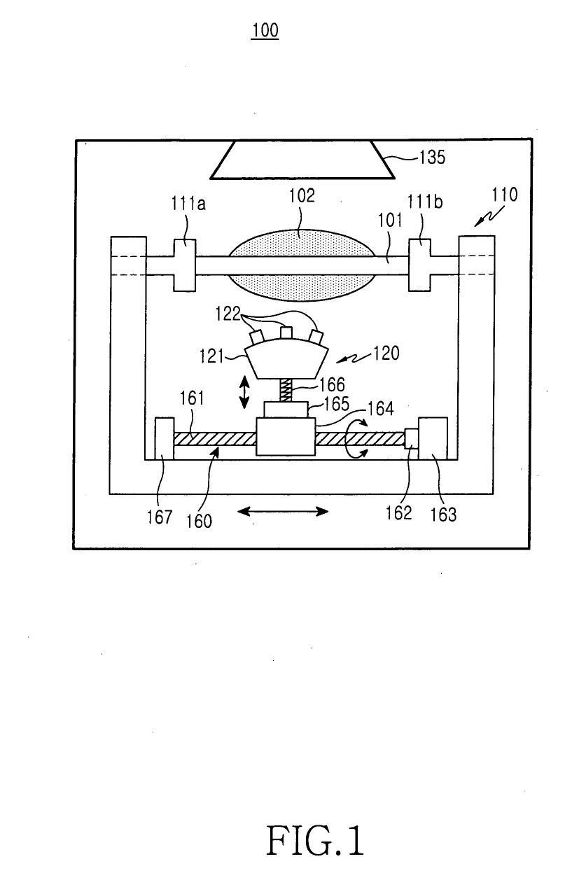

FIG. 1 is a view illustrating an apparatus 100 for fabricating an optical fiber preform via an external vapor deposition process according to the embodiment of the present invention.

As shown, the apparatus 100 includes a lathe 110 on which a primary preform 101 is rotatably supported by means of chucks 111a and 111b, a burner assembly 120 including a plurality of burners 122 for spraying source gas and flame around the primary preform 101, and a carrier unit 160 for moving the burner assembly 120 lengthwise along the primary preform 101. The primary preform 101 includes high-purity glass having a predetermined refractive index. Soot is deposited around the primary preform 101 while the optical fiber preform is being fabricated.

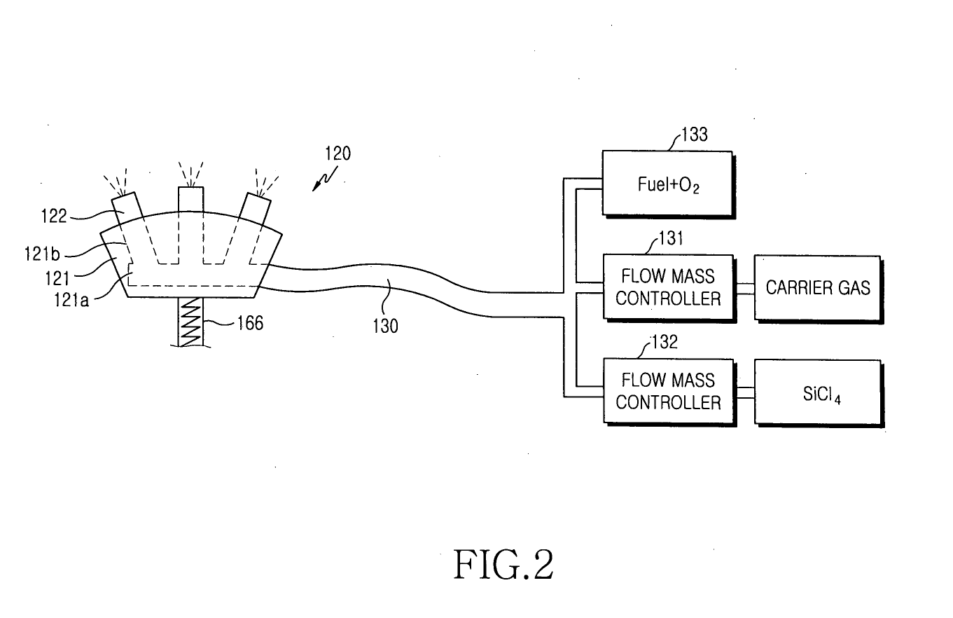

FIG. 2 is a schematic view illustrating the burner assembly 120 shown in FIG. 1 in details. As shown, the burner assembly 120 includes a burner installation block 121 having an inclined surface aligned in opposition to the primary preform 101, a plurality of burners 122 installed on the inclined surface of the burner installation block 121 with mutually different gradients, a tube 130 for feeding source gas into the burners 122, a first mass flow controller 132 for controlling an amount of source gas fed into the burners 122, and a second mass flow controller 133 for controlling an amount of combustion gas.

The source gas includes a precursor material, such as SiCl₄, fuel gas fed into the burners in order to allow the burners to generate flames and oxygen (O₂). The source gas is fed into each burner 122. The burners 122 generate flames, and precursor material is oxidized into soot (SiO₂) due to the reaction between oxygen and flames. The soot is gradually deposited lengthwise along the primary preform 101 and is grown in the form of a soot preform 102, thereby forming the optical fiber preform.

The burners 122 are installed on the inclined surface of the burner installation block 121 in such a manner that the burners 122 can spray gas and flames perpendicularly to the inclined surface of the burner installation block 121. Accordingly, flames may not interfere with each other even if a distance between the burners 122 is narrowed. In addition, the soot can be extensively sprayed lengthwise along the primary preform 101, so the deposition rate of the soot can be improved.

Referring back to FIG. 1, the carrier unit 160 includes a step motor 163, a ball screw 161 coupled to the step motor 163 through a pair of couplers 162 in parallel to the soot preform 102, a ball screw block 164 moving along the ball screw 161 according to the rotation of the ball screw 161 that is driven by the step motor 163, a support block 167 installed on the lathe 110 in opposition to the step motor 163 in order to support the ball screw 161, an air cylinder 165 connected to the ball screw block 164, and a spring 166 positioned between the air cylinder 165 and the burner assembly 120.

The ball screw 161 is formed with a plurality of threads in order to transfer the driving force of the step motor 163 to the ball screw block 164. Accordingly, the ball screw block 164 can move along the ball screw 161 in parallel to the soot preform 102.

In addition, the ball screw block 164 is connected to the air cylinder 165 and the spring 166 on which the burner assembly 120 is mounted. That is, the burner assembly 120 moves lengthwise along the soot preform 102 by means of the ball screw block 164. At this time, the distance between the burner assembly 120 and the soot preform 102 can be adjusted by using the air cylinder 165 and the spring 166. It is also possible to provide a ball screw assembly or a linear guide assembly including a step motor in order to adjust the distance between the burner assembly 120 and the soot preform 102.

The burner assembly 120 shown in FIG. 2 oxidizes the glass precursor under high-temperature conditions, thus forming the soot of SiO₂. The glass precursor and fuel gas are introduced into the tube 130 aligned below the burner assembly 120. The fuel gas includes CH₄ or hydrogen gas, which can generate high-temperature flame by reacting with O₂.

In order to control the mass flow of the glass precursor introduced into the burners shown in FIG. 2, a reservoir containing SiCl₄ is heated to raise vapor pressure and then, the first mass flow controller 132 operates to control the mass flow of the glass precursor. In addition to the first mass flow controller 132, a pressure based flow controller capable of directly controlling the internal pressure of the reservoir or a differential pressure flow controller capable of controlling the mass flow based on the differential pressure in the reservoir may be employed.

In order to prevent condensation of activated SiCl₄ vapor when the glass precursor is fed into the burners shown in FIG. 2, it is necessary to maintain the tube in the high-temperature state. In addition, carrier gas can be used for easily transferring the vapor. The carrier gas includes O₂, Ar or He. The carrier gas is fed into the burner assembly 120 by means of a separate controller 131.

The apparatus 100 for fabricating the optical fiber preform shown in FIG. 1 may further include a collecting unit 135 for collecting and exhausting a part of source gas which is not oxidized into the soot.

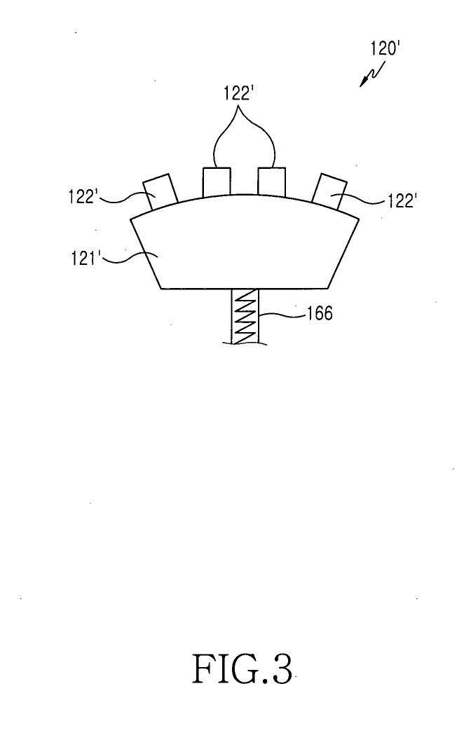

FIG. 3 is a schematic view illustrating the structure of a burner assembly 120′ having four burners according to another embodiment of the present invention. As shown, the burner assembly 120′ includes a burner installation block 121′ having an inclined surface and four burners 122′ installed on the inclined surface of the burner installation block 121′ with mutually different angle.

In addition, the method for fabricating the optical fiber preform includes the steps of rotating the primary preform 101 rotatably supported on the lathe 110 by means of the chucks 111a and 111b, moving the burner assembly 120 from one end to the other end of the primary preform 101, and generating flame by using combustion gas fed into the burner assembly 120 through the tube 130 connected to the lower portion of the burner assembly 120.

The primary preform 101 has an outer diameter of about 20 to 40 mm, and a length of about 1000 to 1600 mm. Preferably, the primary preform 101 is made from high-purity glass having a length of about 1200 to 1400 mm. The refractive index of the high-purity glass can be adjusted to a desired level by using at least two precursors and materials used for controlling the refractive index, such as SiCl₄, GeCl₄, POCl₃, C₂F₆ or Cl₂.

As SiCl₄ and carrier gas are fed into the burner assembly 121 through the tube 130 connected to the lower portion of the burner assembly 121, SiCl₄ is oxidized into soot (SiO₂) through the flame oxidation reaction between SiCl₄ and flame generated from burners 122. The soot is deposited on the primary preform 101.

That is, the soot is deposited on the surface of the primary preform 101 due to the thermophoresis effect and the deposited soot is grown into the soot preform 102. Herein, the thermophoresis effect signifies a phenomenon in which high-temperature particles are moved towards low-temperature particles.

Since the present invention includes a plurality of burners 122 having mutually different gradients, the flames generated from the burners 122 can be sprayed onto the primary preform 101 with different spraying angles so that the moving distance of the soot may be lengthened, thus resulting in the increase of the deposition rate.

That is, the burners 122 are installed on the inclined surface while being aligned perpendicularly to the inclined surface, so that the gradient of the burners 122 depends on a curvature of the inclined surface of the burner installation block 121.

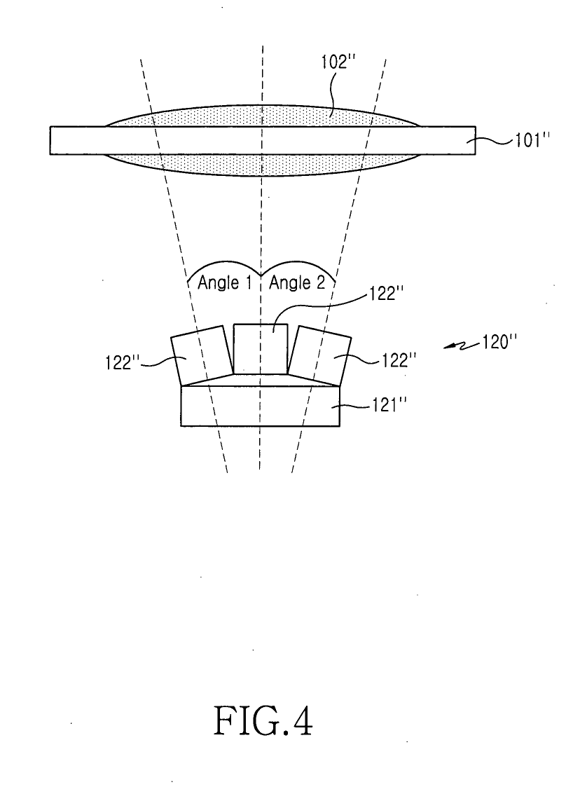

FIG. 4 is a schematic view illustrating the structure of a burner assembly 120″ having three burners 122″ according to still another embodiment of the present invention. As shown, at least one of three burners 122″ is aligned perpendicularly to the longitudinal axis of a primary preform 101″ and remaining burners 122″ are aligned with gradients of about 0 to 15° with respect to the burner perpendicular to the primary preform 101″. If the gradients of the burners significantly deviate the above range, the deposition rate of soot 102″ may be degraded. Accordingly, gradients (angle 1 and angle 2) of the burners may be the same or different from each other.

If the number of burners 122 is insufficient, the deposition rate per unit time may be degraded. In contrast, if too many burner 122 are provided, the soot can not be evenly deposited on the primary preform.

While the burner assembly 120 is being moved lengthwise along the ball screw 161, an outer diameter of the primary preform may increase due to the deposition of the soot, so that the distance between the soot preform 102 and the burners 122 becomes narrowed. Thus, interference may occur between flames generated from the burners 122, thereby lowering the deposition rate of the soot.

According to the present invention, the burner assembly 120 can be vertically moved in the downward direction at a predetermined speed by means of the air cylinder 165 and the spring 166, so the distance between the soot preform 102 and the burner 122 can be constantly maintained. Preferably, the burner assembly 120 moves in the downward direction at a speed of 0.01 to 0.1 mm/min. More preferably, the burner assembly 120 moves in the downward direction at a speed of 0.03 to 0.07 mm/min.

The apparatus 100 of the present invention can fabricate an optical fiber preform having an outer diameter deviation less than 0.5% while improving the deposition rate of the soot. The fabricated optical fiber preform is transparently sintered in an electric furnace having a high temperature above 1500° C. and is subject to a drawing process in a drawing tower.

The apparatus for fabricating the optical fiber preform includes a plurality of burners capable of spraying source gas and flames with mutually different spraying angles, so the amount of oxidized soot deposited on the primary preform can be increased. As a result, the oxidization reaction of the source gas and the deposition rate of the soot per unit time can be improved. Moreover, the amount of the source gas, which is wasted without being oxidized, can be minimized. Furthermore, since the plural burners are integrated in the form of the burner assembly, an installation space thereof can be reduced.

According to the present invention, the burners spray flames towards the primary preform with different spraying angles, so that the interference between flames can be prevented and the optical fiber preform has a uniform thickness. Therefore, the apparatus for fabricating the optical fiber preform according to the present invention can improve the deposition rate of the soot, usage of the source gas, and life span of the burners.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An apparatus for fabricating an optical fiber preform using an external vapor deposition process, the apparatus comprising:
a lathe on which a primary preform is rotatably mounted by means of chucks;
a burner assembly including a burner installation block having an inclined surface and a plurality of burners installed on the inclined surface of the burner installation block in such a manner that the burners spray flames and source gas towards the primary preform with mutually different spraying angles; and
a carrier unit for moving the burner assembly lengthwise along the primary preform.

2. The apparatus as claimed in claim 1, wherein the carrier unit includes a step motor, a ball screw coupled to the step motor through a coupler in parallel relation to the primary preform, a ball screw block moving along the ball screw as the ball screw rotates by means of the step motor, and a support block aligned on the lathe in opposition to the step motor in order to support the ball screw.

3. The apparatus as claimed in claim 1, wherein a plurality of tubes are introduced into the burner installation block and coupled with the burners for feeding the source gas into the burners.

4. The apparatus as claimed in claim 1, wherein the source gas includes SiCl₄, fuel gas for generating the flame, and oxygen.

5. The apparatus as claimed in claim 1, further comprising a device for collecting and exhausting a part of the source gas.

6. The apparatus as claimed in claim 4, wherein the burner installation block includes a mass flow controller for controlling an amount of the source gas fed into each tube.

7. The apparatus as claimed in claim 1, wherein the burners are installed on the inclined surface of the burner installation block with mutually different gradients in order to spray frames lengthwise along the primary preform with different spraying angles.

8. The apparatus as claimed in claim 1, wherein the burner assembly includes at least two burners.

9. The apparatus as claimed in claim 1, wherein at least two of the burners are inclined an angle of about 0 to 15° with respect to the primary preform.

10. The apparatus as claimed in claim 1, wherein at least one of the burners are aligned perpendicularly to a longitudinal axis of the primary preform.

11. The apparatus as claimed in claim 1, wherein gradients of the burners with respect to the primary preform are identical to each other.

12. The apparatus as claimed in claim 1, wherein angles of the burners with respect to the primary preform are different from each other.

13. The apparatus as claimed in claim 1, further comprising a controller for supplying a carrier gas into the burner assembly.

14. An apparatus for fabricating an optical fiber preform using an external vapor deposition process, the apparatus comprising:
a lathe on which a primary preform is rotatably mounted by means of chucks;
a burner assembly including a burner installation block having an inclined surface and a plurality of burners installed on the inclined surface of the burner installation block in such a manner that the burners spray flames and source gas towards the primary preform with mutually different spraying angles; and
a carrier unit for moving the burner assembly lengthwise along or perpendicularly to the primary preform.

15. The apparatus as claimed in claim 14, wherein the carrier unit includes an air cylinder coupled to a ball screw block and a spring positioned between the air cylinder and the burner assembly.

16. The apparatus as claimed in claim 14, wherein the burner assembly moves perpendicularly to the primary preform at a speed of about 0.01 to 0.1 mm/min.

17. The apparatus as claimed in claim 14, wherein the carrier unit includes a ball screw or a linear guide driven by a step motor.

18. The apparatus as claimed in claim 14, further comprising a controller for supplying a carrier gas into the burner assembly.
